(19) United States
(12) Patent Application Publication
(10) Pub. No.: US 2010/0111773 A1
(43) Pub. Date: May 6, 2010

(54) APPARATUS AND METHOD FOR RECOVERING FLUID FROM A FLUID ABSORBING ELEMENT

(76) Inventor: Panagiotis Pantelidis, Middlesex (GB)

Correspondence Address: Intellectual Property Dept.;Dewitt Ross & Stevens SC, 2 East Mifflin Street, Suite 600, Madison, WI, 53703-2865, US

(21) Appl. No.: 12/593,214

(22) PCT Filed: Mar. 28, 2008
(86) PCT No.: PCT/GB2008/001056

§ 371 Date: Oct. 28, 2009

(30) Foreign Application Priority Data
Mar. 30, 2007 (GB) 0706281.3

(51) Int. Cl. B01L 3/00

(52) U.S. Cl. 422/102

(57) ABSTRACT

Nucleic acid recovery apparatus is provided that comprises a lysis vial and a collection vial, each vial having a rim surrounding an opening through which fluid can enter the vial, the apparatus comprising connection means for removably connecting the vials together to form a sealed vessel, the sealed vessel being for placing in a centrifuge. A swab is located in the vessel, with a fluid absorbing element of the swab held in the lysis vial. The vessel is placed in a centrifuge with the lysis vial uppermost and is centrifuged such that the lysis vial takes an inner path and the collection vial takes an outer path such that fluid collects in the collection vial away from the fluid absorbing element.

This invention relates to the recovery of fluid from fluid absorbing elements. In particular, but not necessarily exclusively, it relates to the recovery of fluid from swabs containing dissolved nucleic acid.

Samples containing DNA/RNA (nucleic acid), for extraction in clinical diagnostic labs and in forensic science labs, are often collected using swabs. The swabs usually comprise, at one end of a handle, a fluid absorbing element, e.g. of cotton or viscose, which holds the sample. The samples may be, for example, buccal samples that can be used to diagnose viruses, or, in the case of forensics, samples taken from crime scenes.

One method of extracting the DNA/RNA from the swabs is to submerge the swabs in a lysis buffer fluid. The lysis buffer fluid causes cells, viruses etc. contained in the sample to release DNA/RNA that they carry. A problem with this method is that some of the fluid containing the dissolved DNA/RNA is retained by the fluid absorbing element of the swab. Known methods of recovering this retained fluid include squeezing the swab against the side of a vessel or sucking the fluid from the swab with a pipette. In another known method, the swab is placed in a vessel and into a centrifuge such that the fluid absorbing element of the swab is lowermost in the centrifuge, i.e. the fluid absorbing element is beneath the handle in the centrifuge, before a step of centrifuging commences. The centrifugal force of the centrifuge causes some of the retained fluid to be expelled from the swab.

Once the DNA/RNA has been recovered from the swab, it is isolated using, for example, phenol/chloroform extraction or a commercial isolation kit such as a Qiagen™ column. The technique of Polymerase Chain Reaction (PCR) can then be used to amplify the genetic material for analysis. Although this technique is very sensitive, it can fail to deliver satisfactory results if the amount of DNA/RNA extracted is insufficient. This is particularly a problem where the amount of DNA/RNA present in the original sample is small. Accordingly, it is desirable to extract as much fluid containing dissolved DNA/RNA as possible from a lysed swab.

In US 2003/0091989 and US 2005/0191619 methods are disclosed for purifying nucleic acid from sources heavily contaminated with high particulate material, such as cellular debris and solids. A small-pore membrane acts as a size exclusion barrier, allowing the liquid to pass through, but trapping the particles, including cells, bacteria, viruses, oocysts, and other microbes, as well as other similar-sized particulates in suspension.

In a first aspect, the present invention provides nucleic acid recovery apparatus comprising a first vial and a second vial, each vial having a rim surrounding an opening through which fluid can enter the vial, the apparatus comprising connection means for removably connecting the vials together to form a sealed vessel, the sealed vessel being for placing in a centrifuge.

In use, a fluid absorbing element of a swab, which holds a sample containing DNA/RNA (nucleic acid), is preferably submerged in a lysis buffer fluid that is provided in the first vial, with a handle of the swab projecting from the opening of the first vial. The second vial is preferably located over the handle of the swab and connected to the first vial via the connection means in order to form a sealed vessel. The rims of the first and second vials may be connected together by the connection means to form the sealed vessel. The sealed vessel is then preferably placed in a centrifuge. Preferably, the sealed vessel is located in the centrifuge with the first vial higher than the second vial. Preferably, during spinning, the vessel is arranged such that the first vial takes an inner circumferential path and the second vial takes an outer circumferential path. Therefore, upon placement of the vessel into the centrifuge, and during subsequent spinning, the handle can maintain the fluid absorbing element in the first vial. Furthermore, since the first and second vials take inner and outer paths respectively during spinning, fluid is recovered from the fluid absorbing element whereupon it collects in the second vial, away from the fluid absorbing element. Subsequently, the first and second vials may be removed from the centrifuge and separated.

The inventor has found that this arrangement has several advantages over known prior art devices and methods. In particular, the process of recovery of fluid containing dissolved DNA/RNA may be quicker, and handling difficulties and potential cross-contamination may be reduced since there may be no need for additional recovery steps to be carried out on the swab.

The following features are optional or preferred features of the invention, which may be applied either alone or in combination with the first aspect, or with any other aspect.

The connection means may be integral to the first and second vials. Preferably the connection means is provided by the first and second vials each having a complimentary screw thread located proximate their rims, so that the first and second vials can be removably connected together by screwing their screw threads together. Thus, the first and second vials may be easily connected and disconnected, and a good seal may be achieved between them when they are connected.

As an alternative, the connection means may be provided by the first and second vials having complimentary snap fittings proximate their rims, so that the first and second vials can be removably snap-fitted together.

The first and second vials may each comprise a sidewall and an end wall, the sidewall being disposed between the rim and the end wall, the rim and end wall being located at first and second ends respectively of each vial. The sidewall and end wall of each of the first and second vials surrounds a respective cavity. Preferably, the sidewall is cylindrical. Further, the end wall of the first vial is preferably flat, for supporting the vial on a flat surface, and the end wall of the second vial is preferably conical, for locating in a receiving portion of a centrifuge.

The lengths of the cavities of the first and second vials between their respective first and second ends, may be substantially equal. Preferably, the length of the cavity of one of the first and second vials, between its first and second ends, is between: 25 and 100%; 50% and 100%; 60% and 100%; or 75% and 100% of the length of the cavity of the other of the first and second vials, between its first and second ends. The first vial, more particularly the cavity of the first vial, is preferably dimensioned to accommodate a fluid absorbing element of a swab (e.g. a cotton element) and the second vial, more particularly the cavity of the second vial, is preferably dimensioned to accommodate a handle of the swab, when the vials are connected together to form a sealed vessel. The swab may be a buccal swab.

The apparatus may further comprise a storage cap for sealing the opening of the second vial when the first and second vials are disconnected. Preferably, when the second vial has a screw thread, the storage cap comprises a complimentary screw thread so that the second vial can be sealed by the storage cap by screwing the screw threads together. Preferably, when the second vial has a snap fitting, the storage cap comprises a complimentary snap fitting so that the second vial can be sealed by the storage cap by snap-fitting together.

In some embodiments the apparatus further comprises a swab. When the vials are connected together, the first vial preferably accommodates a fluid absorbing element of the swab, and the second vial preferably accommodates a handle of the swab.

Preferably, the first vial comprises means for engaging the fluid absorbing element, e.g. one or more protrusions, that may be in the form of blades, so that the fluid absorbing elements can remain fixed, temporarily and/or permanently, to the first vial. Furthermore, the protrusions may serve to centre the fluid absorbing element in the first vial, so that lysis fluid can travel all the way round it.

In a second aspect, the present invention provides a vial configured as the first vial in the apparatus according to the first aspect.

In a third aspect, the present invention provides a vial configured as the second vial in the apparatus according to the first aspect.

In a fourth aspect, the present invention provides a method of recovering fluid from a fluid absorbing element, the method comprising the steps of:
(a) positioning the fluid absorbing element having absorbed fluid proximate a first end of an elongate vessel having first and second ends,
(b) sealing the elongate vessel, and
(c) locating the sealed vessel in a centrifuge with the first end of the vessel higher than the second end of the vessel, and centrifuging the sealed vessel such that the fluid absorbed by the fluid absorbing element collects at the second end of the vessel under the centrifugal force.

In a fifth aspect, the present invention provides a method of recovering fluid from a fluid absorbing element, the method comprising the steps of:
(a) positioning the fluid absorbing element having absorbed fluid proximate a first end of an elongate vessel having first and second ends,
(b) sealing the elongate vessel, and
(c) locating the sealed vessel in a centrifuge with the first and second ends of the vessel positioned to take inner and outer paths of rotation respectively during centrifuging, and centrifuging the sealed vessel such that the fluid absorbed by the fluid absorbing element collects at the second end of the vessel under the centrifugal force.

Preferably, in the fourth or fifth aspect, the fluid absorbing element is held away from the second end of the sealed vessel during centrifuging.

Preferably, the sealed vessel comprises a first vial and a second vial, as the sealed vessel described above with respect to the first aspect of the present invention. The first vial may provide the first end of the elongate vessel and the second vial may provide the second end of the elongate vessel.

The inventor has found that by arranging the sealed vessel in the centrifuge and centrifuging in this manner, higher levels of fluid extraction from the fluid absorbing element can be achieved than by using prior art methods. Known methods of extracting retained fluid from swabs achieve at best 60-70% extraction of the retained fluid. In contrast, the present invention may recover in the region of 95% of the retained fluid. From this, the overall recovery of DNA/RNA is expected to improve by in the region of 58%.

The recovered fluid preferably contains dissolved nucleic acid. Thus, a high proportion of the nucleic acid present in the fluid can be extracted from the fluid absorbing element, in order that the chances of retrieving a useful result from a later analysis, such as a Polymerase Chain Reaction (PCR), are increased.

A spacing means may maintain the fluid absorbing element proximate the first end of the vessel, and at a distance from the second end of the vessel. Preferably, the fluid absorbing element and the spacing means are comprised in a swab, and the spacing means may be a handle of the swab.

Preferably, the method further includes the initial step of submerging the fluid absorbing element in a fluid such that the fluid absorbing element absorbs the fluid.

Embodiments of the present invention will now be described by way of example only, with reference to the accompanying drawings, in which:

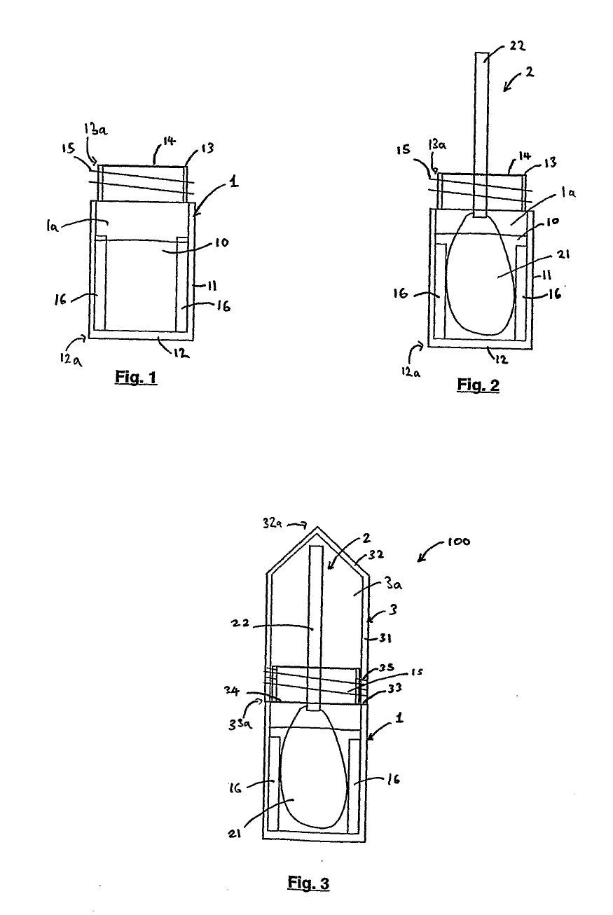

FIG. 1 shows a cross-sectional side view of a lysis vial according to a first embodiment of the present invention;

FIG. 2 shows a cross-sectional side view of swab located in the lysis vial of FIG. 1;

FIG. 3 shows a cross-sectional side view of a collection vial connected to the lysis vial of FIG. 1, to form a sealed vessel enclosing the swab of FIG. 2;

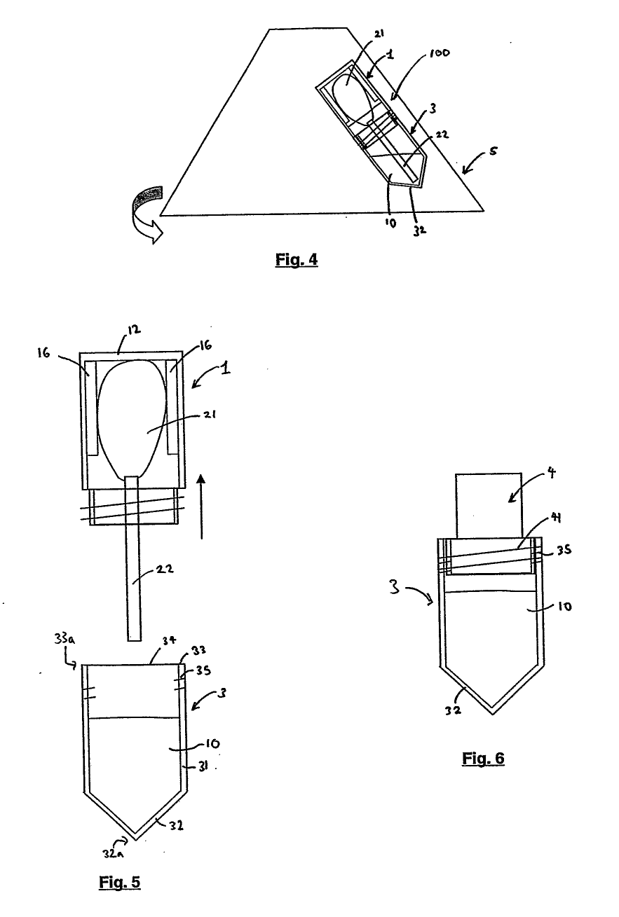

FIG. 4 shows cross-sectional side view of the sealed vessel of FIG. 3 in a centrifuge;

FIG. 5 shows cross-sectional side view of the lysis vial and the collection vial separated after centrifuging in the centrifuge of FIG. 4;

FIG. 6 shows cross-sectional side view of the collection vial of FIGS. 3, 4 and 5 having a closure storage cap;

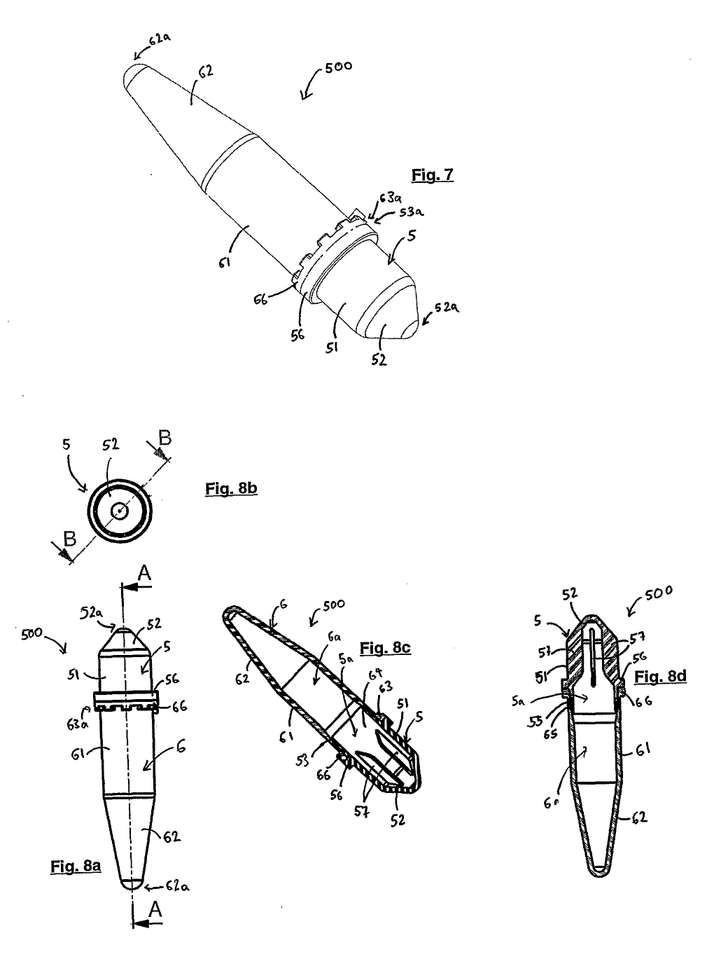

FIG. 7 shows an oblique view of a sealed vessel comprising a lysis vial and a collection vial according to a second embodiment of the present invention;

FIG. 8a shows a side view of the sealed vessel of FIG. 7,

FIG. 8b shows a top view of the sealed vessel of FIG. 7;

FIG. 8c shows a cross-sectional view of the sealed vessel along line A-A in FIG. 8a;

FIG. 8d shows a cross-sectional view of the sealed vessel along line B-B in FIG. 8b;

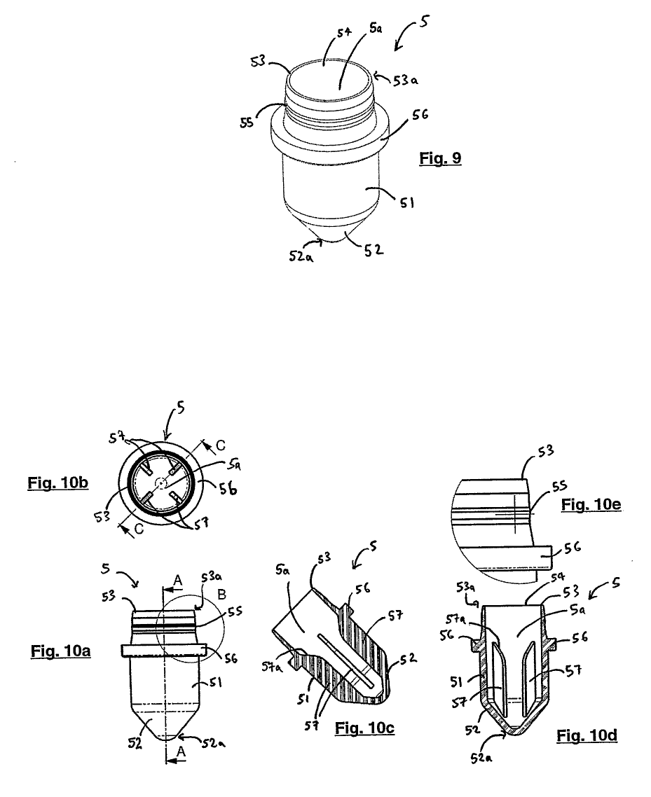

FIG. 9 shows an oblique view of the lysis vial comprised in the vessel of FIG. 7;

FIG. 10a shows a side view of the lysis vial of FIG. 9,

FIG. 10b shows a top view of the lysis vial of FIG. 9;

FIG. 10c shows a cross-sectional view of the lysis vial along line C-C in FIG. 10b;

FIG. 10d shows a cross-sectional view of the lysis vial along line A-A in FIG. 10a; and

FIG. 10e shows an enlarged view of the lysis vial at area B circled in FIG. 10a.

FIG. 1 shows lysis vial 1 containing lysis fluid 10 according to a first embodiment of the present invention. The lysis vial 1 has a cylindrical side wall 11 extending between first and second ends 12a, 13a of the vial 1. At the first end 12a, the vial 1 has a flat end wall 12, which allows the vial 1 to be seated on a flat surface. At the second end 13a of the vial 1, the vial has a rim 13 that surrounds an opening 14 through which fluid can enter a cavity 1a of the vial. Proximate the rim 13 is an external screw thread 15 which enables the lysis vial 1 to be connected to a collection vial 3, as described further below.

The cavity 1a of the lysis vial 1 is dimensioned to receive a fluid absorbing element 21, such as a cotton or viscose element, of a swab 2.

In order to extract DNA from a sample of cells or viruses held in the fluid absorbing element 21, the following steps are carried out.

Firstly, the fluid absorbing element 21 is submerged in the lysis fluid 10 in the cavity 1a of the lysis vial 1, as shown in FIG. 2. A handle 22, connected to the fluid absorbing element 21, projects from the opening 14 of the lysis vial 1. Protrusions 16 provided on the inside walls of the cavity 1a grip the fluid absorbing element 21, so serving to provide a temporary connection between the swab 2 and the lysis vial 1. Furthermore, the protrusions 16 may aid location of the fluid absorbing element 21 in the centre of the cavity 1a of the vial 1, so that space may be provided for lysis fluid to travel all the way round the absorbing element 21.

When the fluid absorbing element 21 is submerged in the lysis fluid 10, it absorbs some of the lysis fluid 10. This submersion, which may be prolonged, causes the DNA/RNA contained in any cells or viruses to be released or dissolved into the lysis fluid 10.

Next, a collection vial 3 is connected to the lysis vial 1, to form a sealed elongate vessel 100, as shown in FIG. 3, which encloses the swab 2. The collection vial 3 has a cylindrical side wall 31 extending between first and second ends 32a, 33a of the vial 3. At the first end 32a, the vial 3 has conical end wall 32. At the second end 33a, the vial 3 has a rim 33 that surrounds an opening 34 through which fluid can enter a cavity 3a of the vial 3. Proximate the rim 33 is an internal screw thread 35, which is screwed to the screw thread 15 of the lysis vial 1 to form the sealed elongate vessel 100. The length of the cavity 1a between the first and second ends 12a, 13a of the lysis vial 1 is about the same length as the cavity 3a between the first and second ends 32a, 33a of the collection vial 3.

Subsequently, the sealed elongate vessel 100 is incubated and then placed in a centrifuge 5 in an inverted position, as shown in FIG. 4, i.e. with the lysis vial 1 above the collection vial 3.

The vessel 100 is spun in the centrifuge 5, causing liquid 10 to move from the fluid absorbing element 21 to the collection vial 3 under the centrifugal force (since lysis vial 1 and collection vial 3 travel along inner and outer paths respectively during spinning). The handle 22 of the swab 2 maintains the fluid absorbing element 21 at a distance from the conical end wall 32 of the collection vial 3.

Afterwards, the sealed elongate vessel 100 is removed from the centrifuge 5, and the lysis vial 1 and collection vial 3 are disconnected (see FIG. 5). After disconnection, the fluid absorbing element 21 remains connected to the lysis vial 3 via the protrusions 16, so that the lysis vial 3 and swab 2 can be discarded as one, with no hand-contact of the swab 2 required.

The collection vial 3, containing the collected fluid 2, may then be stored and/or extraction of DNA from the fluid 2 may be carried out. For storage, a storage cap 4 is provided, which has a screw thread 41 for screwing to the screw thread 35 of the collection vial 3, to seal its opening 34.

A sealed elongate vessel 500, comprising a lysis vial 5 and a collection vial 6, according to a second embodiment of the present invention, is shown in FIG. 7 and FIGS. 8a to 8d. The lysis vial 5 and the collection vial 6 function, and are used, in generally the same manner as the corresponding vials 1, 3 of the first embodiment. However. the shapes of the lysis vial 5 and collection vial 6, and the manner in which the lysis vial 5 and collection vial 6 connect together, are different from the corresponding vials 1, 3 of the first embodiment.

The lysis vial 5 of the second embodiment is shown in more detail in FIGS. 9 and 10a to 10e. The lysis vial 5 has a cylindrical side wall 51 extending between first and second ends 52a, 53a of the vial 5. Unlike the first embodiment, a conical end wall 52 is provided at the first end 52a of the lysis vial 5. At the second end 53a, a rim 53 is provided that surrounds an opening 54 through which fluid can enter a cavity 5a of the vial 5. Proximate the rim 53, projecting circumferentially around the side wall of the vial, is a snap-fit projection 55, which enables the lysis vial 5 to be releasably connected to the collection vial 6, as discussed further below.

Referring again to FIGS. 7 and 8a to 8d, the collection vial 6 of the second embodiment is a standard microcentrifuge tube, in particular an Eppendorf® tube. Accordingly, like the collection vial 6 of the first embodiment, it has a cylindrical side wall 61 extending between first and second ends 62a, 63a of the vial 6. At the first end 62a, the vial 6 has a conical end wall 62. At the second end 63a, the vial 6 has a rim 63 that surrounds an opening 64 through which fluid can enter a cavity 6a in the vial 6. Proximate the rim 63 is an internal snap-fit recess 65, which is arranged to receive the snap-fit projection 55 of the lysis vial 5, in order to releasably snap-fit the two together to form the sealed elongate vessel 500. When snap-fitted together, respective circumferential flanges 56, 66, proximate the rims 53, 63 of the vials 5, 6 abut against one another.

The lysis vial 5 comprises elongate blade-like protrusions located on the inside of the side wall 51 and end wall 52, in the inner cavity 5a of the lysis vial 5, to grip the fluid absorbing element 21 as described above with respect to the first embodiment. Each protrusion 57 extends over halfway along the inside of the cavity 5a, between the first and second ends 52a, 53a of the lysis vial 5. The protrusions 57 are distributed evenly around the circumference of the cavity 5a so that they aid location of the fluid absorbing element in the centre of the lysis vial 5. Facets 57a of the protrusions 57 facing the opening 54 of the lysis vial 5 are inclined to enable the fluid absorbing element 21 to be moved with little obstruction into the cavity 5a, into a position in which the element 21 is gripped by the protrusions 57.

By using a standard Eppendorf® tube, which is produced in large numbers at low cost, manufacturing time and costs for producing the components of the vessel 500 may be reduced.

In the second embodiment, the length of the cavity 5a between the first and second ends 52a, 53a of the lysis vial 5 is about 40% of the length of the cavity 6a between the first and second ends 62a, 63a of the collection vial 6.

1-30. (canceled)

31. A fluid recovery device for recovering fluid from a fluid absorbing element, the fluid absorbing element including a swab and a spacing element, the device including first and second vials, each including a chamber provided with a rim surrounding an opening to the container through which fluid can enter the container, the first vial being dimensioned to hold the swab and the second vial being dimensioned to hold the spacing element, the rims of the first and second vials including connection elements for removably connecting the vials together at their rims in opposing relationship such that the vials connect together to form a sealed vessel, the sealed vessel being for placing in a centrifuge.

32. The device of claim 31, wherein the connection elements are integral with the first and second vials.

33. The device of claim 32, wherein the connection elements include:
a. a screw thread located proximate the rims of each of the first and second vials, such that the first and second vials can be removably connected together by screwing their screw threads together; or
b. a snap-fit element located proximate the rims of each of the first and second vials, such that the first and second vials can be removably connected together by snap-fitting together.

34. The device of claim 31, wherein each of the first and second vials includes a side wall extending between first and second ends of the vial, and an end wall located at the first end of the vial, wherein the rim is located at the second end of the vial and the side wall and end wall provide the chamber of the vial.

35. The device of claim 34, wherein the end wall of the first vial is flat, for supporting the vial on a flat surface.

36. The device of claim 34, wherein the end wall of the second vial is conical, for locating in a receiving portion of a centrifuge.

37. The device of claim 34, wherein lengths of the cavities of the first and second vials between their respective first and second ends are substantially equal; or the length of the cavity of one of the first and second vials between the first and second ends of the vial is between 25% and 100%, 50 and 100%, 60% and 100% or 75% and 100% of the length of the cavity of the other of the first and second vials between the first and second ends of the vial.

38. The device of claim 31, wherein the first vial includes internal protrusions to grip the swab of a fluid absorbing element.

39. The device of claim 31, including a storage cap for sealing the opening of the second vial when the first and second vials are disconnected.

40. The device of claim 3, wherein the storage cap includes a screw thread for sealing to the second vial.

41. The device of claim 31, wherein the second vial is an Eppendorf® tube.

42. A fluid recovery device for recovering fluid including:
a. a fluid absorbing element having a swab and a spacing element;
b. first and second vials, each including a container provided with a rim surrounding an opening to the container through which fluid can enter the container, the first vial being dimensioned to hold the swab and the second vial being dimensioned to hold the spacing element, the rims of the first and second vials including connection elements for removably connecting the vials together at their rims in opposing relationship such that the vials connect together to form a sealed vessel, the sealed vessel being for placing in a centrifuge.

43. The device of claim 42, wherein the spacing element is a handle.

44. The device of claim 42, wherein the spacing element acts to hold the swab in the first vial during centrifuging.
